(19) United States
(12) Patent Application Publication
(10) Pub. No.: US 2011/0304129 A1
(43) Pub. Date: Dec. 15, 2011

(54) Combination Wheel Skirt Cover and Mud Guard

(76) Inventor: Charles Owens, Columbia, SC (US)

(21) Appl. No.: 13/160,537

(22) Filed: Jun. 15, 2011

Related U.S. Application Data
(60) Provisional application No. 61/354,741, filed on Jun. 15, 2010.

(51) Int. Cl. B62D 25/18

(52) U.S. Cl. 280/849

(57) ABSTRACT

A combination vehicle wheel well cover and mud flap device, comprising a semi-circular wheel well insert and a wrap-around rear flap portion that acts as a protective guard for flying debris ejected from the rotating rear wheel. The device provides a means to customize a vehicle by providing coverage of a rear tire and rim, changing the aesthetic nature of the vehicle, while also improving aerodynamic qualities therefor and further protecting the body from ejected rocks and dirt. A wrap-around portion attaches to the vehicle wheel well and forms a rear mounted mud flap, and also provides a lip for attachment of a wheel well cover. The cover may be removably attached via a row of fasteners to allow the cover to be removed without disassembling the entire assembly.

### CROSS REFERENCE TO RELATED APPLICATION

This application claims the benefit of U.S. Provisional Application No. 61/354,741 filed on Jun. 15^{th}, 2010, entitled “Wheel Skirt Cover.”

### BACKGROUND OF THE INVENTION

1. Field of the Invention

The present invention relates to automobile accessories and devices for application on the wheel well of a vehicle. More specifically, the present invention pertains to a combination wheel well cover and mud guard, attachable to the wheel well of any vehicle rear wheel to partially cover the outer surface of the wheel and tire, and further prevent mud and debris from being ejected into the air behind the vehicle and against the vehicle body.

2. Description of the Prior Art

Vehicle accessories and aftermarket personalization articles account for a large and rapidly growing segment in today's motor vehicle market. Today's motorist takes great pride in the appearance and performance of their vehicles. They enjoy personalizing and upgrading the characteristics of the vehicle, not only aesthetically, but mechanically as well. Products that improve both the visual features of the vehicle as well as serve a functional purpose are highly desired by enthusiasts and everyday motorists.

Today's vehicle consumer has more opportunities than ever to update their stock vehicle to suit particular needs and preferences. These include engine performance upgrades, audio and electronics upgrades, as well as visual appearance modifications that alter the as-manufactured qualities and appearance of the vehicle. Exterior personalization and modifications may take several forms, including various lighting schemes, graphics and bodywork to alter the original manufactured styling or properties to fit a user's preferences. Exterior body and cosmetic changes may take the form of spoilers or wings, air scoops, grills, upgraded wheel rims or wheel accessories.

The present invention aims to provide a further item for customization and visual appeal, while providing a device that also serves a functional purpose. Specifically, the present invention provides an external vehicle wheel accessory that provides partial coverage of a vehicle wheel well and connects to a mud flap wrap-around section that is attached to the vehicle. The wheel well device covers the exterior of the wheel rim and tire, preventing direct and debris from entering. It likewise includes an exterior painted or decorated surface to provide a visual aesthetics that match the overall vehicle paint scheme.

Its coverage of the wheel well serves both a functional and ornamental purpose. An open wheel well creates considerable drag along the sides of the vehicle, increasing the overall vehicle drag coefficient and reducing aerodynamic efficiency, and consequently fuel efficiency. The cover also provides a retro look to the wheel well, as only a partial view of the rim and tire is visible to outside onlookers.

The final aspect of the present invention is the combination mud flap, which comprises a wrap-around section that attaches to the inner surface of the wheel well and extends downward from the rear of the well to provide a protective surface to deflect or collect flying mud, dirt and debris from being liberated into the air due to the rotating wheel over the road surface. These ejected articles have been known to damage both the vehicle responsible, as well as traveling vehicles behind the responsible vehicle. In particular, granular road surfaces or loose rocks can damage body work, fenders, and even crack the windshield of other vehicles. The mud flap deflects or collects rocks, debris and mud before it can damage the vehicle or other nearby vehicles. The wheel well cover is attachable to a lip provided along the wrap-around potion via a row of fasteners, and is removable therefrom. The removable feature allows the wheel cover to be replaced if damaged without necessitating the user to replace the entire wheel well and flap wrap-around assembly.

Wheel well covers and mud flaps have been described in the prior art and in the public domain; however no devices have been disclosed that describe the unique features of the present invention, most notably the combination of two devices and a device that provides both aesthetic and functional features. A majority of the prior art pertains to wheel well covers, mud flaps or fender flares, with no mention of any combination thereof.

U.S. Pat. No. 6,070,908 to Skrzypchak describes one such device, wherein an aluminum diamond plate fender extension is described for fitting to the inner portion of a vehicle wheel well and flaring outward therefrom. The extensions project perpendicularly from the fenders to provide a neat and attractive appearance, as well as a fender protector. No mention is made of a combined fender extension with attached wheel well covers, or an integral mud flap design for the rear fenders.

U.S. Pat. No. 5,340,154 to Scott describes another fender flare removably secured to a vehicle fender. A bonding strip is used to secure the fender flare to the fender outer surface, while a fattener is used to secure the bottom of the fender flare to the inner surface of the wheel well. As with the Skrzypchak patent, no mention is made of a fender flare combination device, wherein a mud flap or wheel cover is attached to the flare for additional utility and functionality.

U.S. Pat. No. 4,169,608 to Logan describes a fender extension that provides an inner flange to attach to the inside surface of a vehicle wheel well. The rear portion of the fender extension provides a projecting surface that may serve to protect the rest of the body from flying debris, similar to a mud flap. However, no mention is made of a wheel cover attachment that covers the wheel and tire to improve looks and aerodynamic performance.

U.S. Pat. No. 4,062,580 to West describes a flanged automotive trim device for attachment to a vehicular wheel well that replaces an existing wheel well cover. The device provides a means to update the styling of a vehicle with an existing wheel well cover by replacing it with a fender flange that utilizes the same bracketry and attachment means as the wheel cover. This device does not describe a wheel well cover combined with a mud flap or fender extension, but rather a replacement for the former that is painless and easily installed with no adulteration to the base vehicle.

The present invention provides a fender flare, mud flap and wheel well cover assembly that combines the uses of all three into an easily installed, simply designed structure that serves both a decorative and functional purpose. It substantially diverges in design elements from the prior art and consequently it is clear that there is a need in the art for an improvement to existing vehicular wheel well accessory devices with functional and decorative uses. In this regard the instant invention substantially fulfills these needs.

### SUMMARY OF THE INVENTION

In view of the foregoing disadvantages inherent in the known types of vehicle wheel well accessories now present in the prior art, the present invention provides a new wheel well accessory wherein the same can be utilized for providing convenience for the user when partially obstructing the view of a rear wheel well using a wheel well cover, combined with a protected mud flap device that provides an easily attachable assembly that is both aesthetically pleasing and functional.

It is therefore an object of the present invention to provide a new and improved vehicle wheel well accessory device that has all of the advantages of the prior art and none of the disadvantages.

It is therefore an object of the present invention to provide combination device that serves both an ornamental purpose and a functional purpose. The wheel well cover covers a large portion of the rear wheel rim and tire and serves to change the look and appeal of the vehicle, while a wrap-around portion provides a wheel well attachment portion and a downwardly projecting, rear mud flap that serves as a protective device for the body of the vehicle and for motor vehicles behind the present vehicle.

Another object of the present invention is to provide an easily attachable device to the wheel well of a vehicle, and one that provides removable attachment of a wheel well cover. The mud flap region is a wrap-around portion that connects to the wheel well of a vehicle. The wrap-around portion provides a lip for attachment of a wheel well cover that may be fitted via a row of fasteners. The removable attachment provides the user with the ability to replace the wheel well skirt without disassembling or replacing the entire assembly. In an alternative embodiment, the wrap-around mud flap portion and skirt are comprised of a single piece.

Yet another object of the present invention is to provide a wheel well device that improves aerodynamic performance of the vehicle by reducing drag in the rear wheel wells.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself, and manner in which it may be made and used, may be better understood by referring to the following description taken in connection with the accompanying drawings. Such description makes use of the annexed drawings with like referenced annotations consistent between drawings.

FIG. 1 shows a side perspective view of the present invention in a working position, attached to the rear wheel well of a vehicle.

FIG. 2 shows another side perspective view of the present invention, clearly showing the attachment between the wheel well wrap-around portion and the fastened wheel well cover.

FIG. 3 shows an inner side view of the present invention.

FIG. 4 shows a rear view of the present invention in a working position, attached to the rear wheel well of a vehicle.

### DETAILED DESCRIPTION OF THE INVENTION

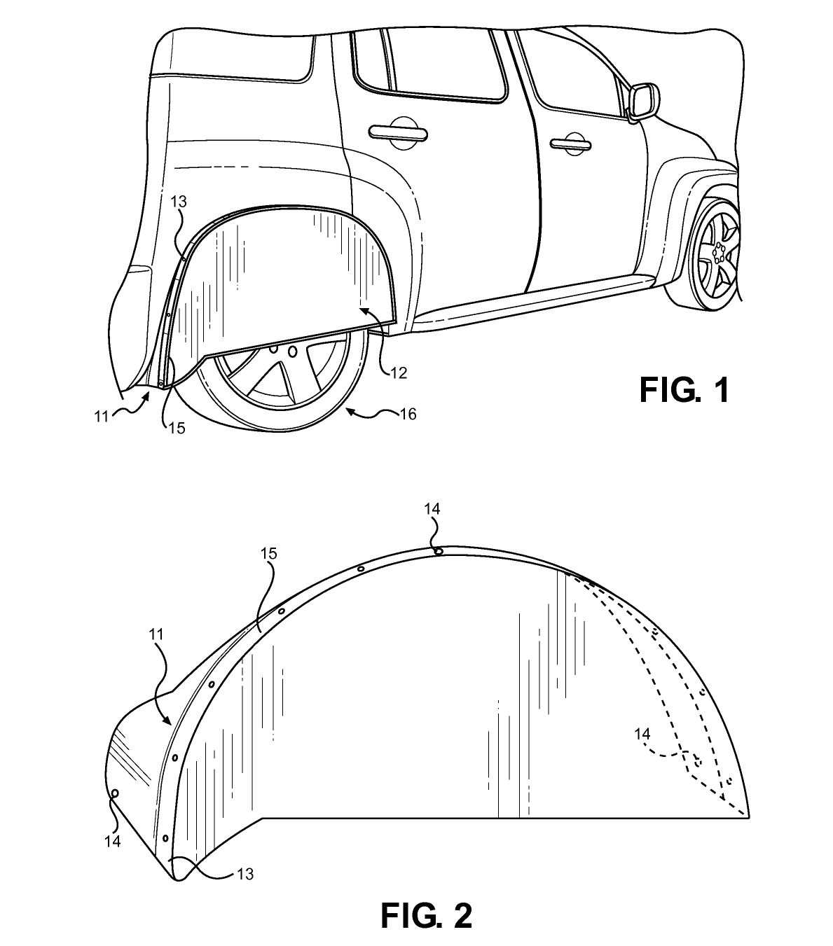

Referring now to FIG. 1, there is shown a side perspective view of the present invention in a working position, attached to the rear wheel well of a motor vehicle. The present invention comprises a device of two-piece construction. A first wheel well wrap-around attachment piece 11 is attached to the inner surface of the vehicle wheel well. The wrap-around piece 11 provides connection along the entire circumference of the wheel well, and terminates at a mud flap extension member in the rear of the wheel well. A lip 15 is provided for connection to a wheel well cover portion 12, which preferably fastens 13 to the lip 15 of the wrap-around portion 11 in a plurality of locations. The wheel well cover is a semi-circular wheel well insert that provides a continuation of the vehicle body down to mid-wheel level 16. The cover itself may be made from aluminum, fiberglass, or other automotive fender material that is lightweight and paintable. The rear section of the cover provides a triangular projection that joins the base of the cover 12 with the base of the wrap-around portion 11 mud flap termination.

Referring now to FIG. 2, there is shown a perspective view of the present invention, which clearly shows the two-piece construction of the device. The wheel well cover 12 fastens to the wrap-around portion 11 at a plurality of fastener locations 13 provided along a lip 15. The lip 15 is a perpendicular projection of the wheel well cover 12 that attaches to a flared shelf region along the wrap-around portion 11. The wrap-around portion 11 affixes to the vehicle wheel well using a plurality of fasteners 14 to secure itself and the mud flap to the vehicle prior to being combined with the wheel cover 12. In this manner, the mud flap and wrap-around region remain connected to the vehicle while the wheel well cover 12 may be removed or replaced. This is particularly useful if the cover 12 is damaged, needs replacing or if quick access to the wheel is necessary in a vehicle break-down situation. The wrap-around portion 11 also provides a very sturdy mud flap that can spread load from the flap to the rest of the wheel well in the event of a collision with a flying stone or similar piece of road debris.

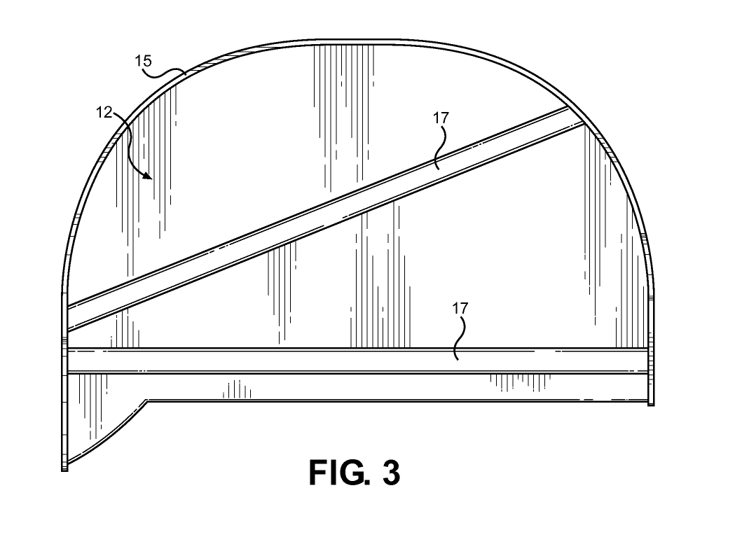

Referring now to FIG. 3, there is shown an inner side view of the wheel well cover portion, wherein the inner surface of the wheel well cover 12 is shown. This view provides visualization of the cover rear projection that mates to the mud flap lower termination. The lip 15 of the cover provides a shelf for which to attach the cover to the wrap-around region, which is connected to the vehicle itself. A pair of panel stiffeners 17 may be provided to stiffen the cover panel and prevent membraning or deflection of the cover 12 under aerodynamic loading. The cover 12 is prevented from contacting the wheel or rim during operation, as this would damage the cover and cause a risk of shattering the cover components or further damaging the vehicle.

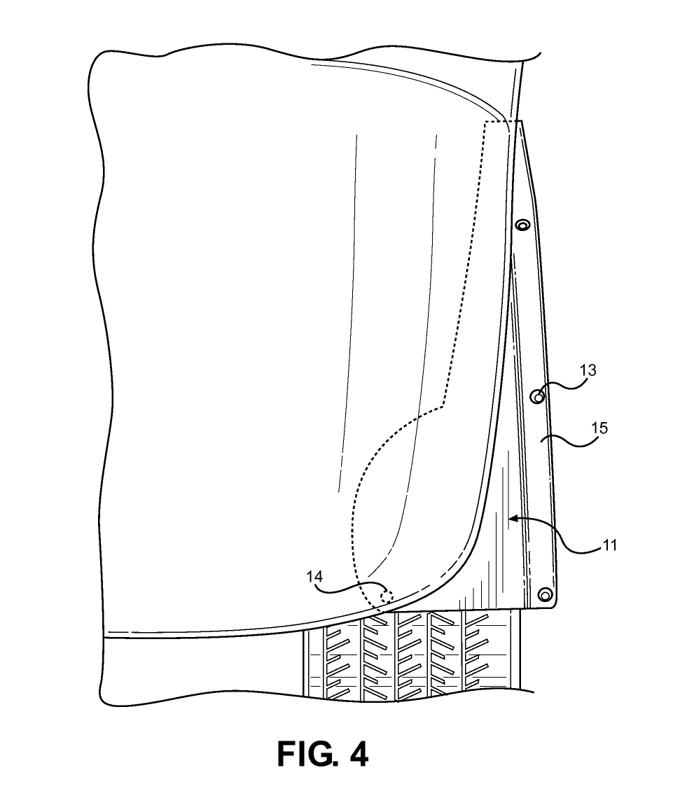

Referring now to FIG. 4, there is shown a rear view of the present invention in a working position, attached to the rear wheel well of a vehicle. The wrap-around portion 11 terminates along the rear of the wheel well in a mud flap projection, which is squared off in alignment with the vehicle tire to provide road debris containment propelled therefrom. The lip 15 of the wheel well cover attaches to the wrap-around portion 11, which flares outward from the wheel well in the mud flap region. The connection between the two components is preferably fasteners of a particular pitch from the front to the rear of the assembly. A plurality of wrap-around fasteners 14 provides connection to the vehicle, and ultimately support for the attached wheel well cover 11 during operation.

In use an individual utilizes the present invention as an aesthetic change or upgrade to the basic styling of a vehicle, while utilizing the functional aspects of the mud flap and coverage of the wheel well. The mud flap provides the user with a device to limit damage to the body of the vehicle while traveling over loose rocks, dirt and debris, which would otherwise be projected onto the vehicle or propelled behind the vehicle. This reduces cost of upkeep on the painted surfaces of the vehicle, and reduces the chance of damaging another motorist's vehicle traveling behind the present vehicle. Coverage of the wheel well further serves to reduce aerodynamic drag and improve fuel economy, particularly at high speeds where aerodynamic drag is considerably higher than rolling drag of the tires. Small reductions in the vehicle overall aerodynamic drag coefficient can yield significant monetary savings over the long term for the user, as he or she can get more miles per tank from the same vehicle.

The preferred embodiment of the present invention uses a piecemeal or modular construction, in which two pieces are fastened together to form a mud flap and wheel well cover combination. This construction allows easy removal of the wheel well cover in the event of damage or when access to the wheel hub is necessary. The wheel covers may likewise be interchangeable, offering the user the ability to update the color or styling of a vehicle by simply attaching a different style wheel cover as desired. In an alternate embodiment, the two portions are combined into a unitary mud flap and wheel well cover.

The fasteners of the present invention are ideally those suited for outdoor use, specifically those that resist corrosion and rust in the presence of dirt and moisture. The wrap-around region is preferably an elastic material such as rubber, although plastics and similar durable, lightweight materials are contemplated. An elastic material allows the wrap-around region to absorb structural loads from the wheel well as it shifts and breathes under load, and provides an elastic mud flap that does not brittlely break upon impact with debris. The wheel well cover may be plastic, ABS plastic, aluminum or any other body fender material that allows for durability and paintability, thus allowing the cover to be painted or adorned to match the rest of the vehicle.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A two-piece, combination vehicular wheel well device, comprising:
a wheel well wrap-around portion adapted to fit along and fasten to an inside surface of a vehicular wheel well;
said wrap-around portion flaring outward from said wheel well inner surface to form a mud flap at said wrap-around portion rear termination;
a wheel well cover comprising a cover panel and a perpendicular lip;
said lip formed to mate against and fasten to said wrap-around portion.

2) A device as in claim 1, wherein said wheel well cover obstructs complete view of said vehicle wheel and tire but does not make contact therewith.

3) A device as in claim 1, wherein a lower termination of said cover mates with said wrap around portion mud flap lower termination.

4) A device as in claim 1, wherein said cover further comprises panel stiffeners along said cover inside surface.

5) A one-piece, combination vehicular wheel well device, comprising:
a wheel well wrap-around portion adapted to fit along an inside surface of a vehicular wheel well;
said wrap-around portion flaring outward from said wheel well inner surface to form a mud flap at said wrap-around portion rear termination;
a wheel well cover comprising a cover panel perpendicularly mated to said wrap-around portion.

6) A device as in claim 5, wherein said wheel well cover obstructs complete view of said vehicle wheel and tire but does not make contact therewith.

7) A device as in claim 5, wherein a lower termination of said cover mates with said wrap around portion mud flap lower termination.

8) A device as in claim 5, wherein said cover further comprises panel stiffeners along said cover inside surface.
